(19) United States
(12) Patent Application Publication
(10) Pub. No.: US 2008/0207291 A1
(43) Pub. Date: Aug. 28, 2008

(54) Baccarat Wagering Method

(76) Inventor: Lucas Daniel Pieter Van Vuuren, Vereeniging (ZA)

Correspondence Address: MICHAEL W. TAYLOR, P.O. BOX 3791, ORLANDO, FL, 32802-3791, US

(21) Appl. No.: 11/722,746

(22) PCT Filed: Jan. 23, 2006
(86) PCT No.: PCT/IB06/50233

§ 371 Date: Oct. 15, 2007

(30) Foreign Application Priority Data
Jan. 24, 2005 (ZA) 2005/0671

(51) Int. Cl. A63F 13/00; A63F 1/00; A63F 3/00

(52) U.S. Cl. 463/12; 273/292; 273/274; 463/25

(57) ABSTRACT

A Baccarat wagering method in which provision is made for placing a bet for a round of play to end in a tie between a player hand and a banker hand, wherein there are a plurality of different payment ratios for a successful tie bet, with each possible card total on which a tie can occur having a pre-defined payment ratio associated therewith. Also bets on the banker hand or player hand to win also have a plurality of different payment ratios for a winning bet, each possible card total on which a winning hand can occur having a pre-defined payment ratio associated therewith. Baccarat playing surfaces for carrying out these wagering methods are also disclosed.

This invention relates to gaming. In particular, the invention relates to a Baccarat wagering method, to a Baccarat playing surface, and to a computer controlled version of Baccarat.

The traditional method of playing Baccarat is as follows:

Baccarat is a card game that is played using more than one deck of cards (typically eight decks) consisting of 52 cards per deck. Joker cards are not used. The cards are shuffled by a dealer before the commencement of the game and are then dealt from a box known as a shoe. Baccarat has three betting options that a betting player can exercise: bets can be placed on the “Player” winning a round of play, the “Banker” winning a round, or a “Tie” between the “Player” and the “Banker”. Players or participants indicate their bets on the “Player”, the “Banker”, or a “Tie” between the “Player” and the “Banker”, by placing tokens on the appropriate fields or zones demarcated on the playing surface. The terms “Player” and “Banker” do not refer to the actual participants and the dealer, but only refer to the available betting options as indicated by the appropriate zones on the table.

The object of the game is to guess which of the two hands dealt (Player or Banker) in a round of play will have a final card total equal to 9, or a card total closest to 9, where 9 is the highest possible count and 0 the lowest count. The card total in a hand is calculated by adding the value of the cards in the hand, modulo 10. In other words, all digits except the least significant digit of the card total are discarded. If the combined total was 15, the card total for the purposes of Baccarat will be 5.

Ace cards have a value of 1, ten cards and picture cards have a value of 0, and all other cards are counted at their face value. For example, if a hand consists of a picture card and a 5, the total count in the hand is 5. The card value can only range from 0 to 9. Suits e.g. Hearts, Diamonds, Clubs or Spades, have no relevance in Baccarat.

Once all bets have been placed, two cards are dealt to each of the Player and the Banker; the first and third cards going to the Player, and the second and fourth cards to the Banker.

Clearly marked areas on the playing surface indicate where the cards for the Player and the Banker are placed.

Each of the Player hand and the Banker hand will always consist of a minimum of two, and a maximum of three cards. If the Player hand requires a third card, it will be dealt before the Banker hand may receive a third card. Rules for determining whether or not a third card is to be dealt are as follows:
if the Player or the Banker has a card total of 8 or 9 on the first two cards, they “stand”, i.e. no further cards are drawn. This rule overrides all other rules;
if the Player's initial two-card total is 5 or less, another card is dealt to the Player, otherwise the Player stands. If the Player stands, the Banker will be dealt another card only if it has an initial two-card total of 5 or less; otherwise the Banker stands; and
if the Player is dealt a third card, the value of this card will determine whether the Banker will also receive a third card or not. The chart below is used for reference to determine whether the Banker will be dealt a third card or not, where “H” (hit) indicates that a further card is dealt and “S” (stand) indicates that no further card is dealt.

| | | Player's third card | | | | | | | | | |
|---|---|---|---|---|---|---|---|---|---|---|---|
| | | 0 | 1 | 2 | 3 | 4 | 5 | 6 | 7 | 8 | 9 |
| Banker's | 7 | S | S | S | S | S | S | S | S | S | S |
| initial | 6 | S | S | S | S | S | S | H | H | S | S |
| two-card | 5 | S | S | S | S | H | H | H | H | S | S |
| total | 4 | S | S | H | H | H | H | H | H | S | S |
| | 3 | H | H | H | H | H | H | H | H | S | H |
| | 2 | H | H | H | H | H | H | H | H | H | H |
| | 1 | H | H | H | H | H | H | H | H | H | H |
| | 0 | H | H | H | H | H | H | H | H | H | H |

The set of rules according to which the cards are dealt in Baccarat is known as the Baccarat Tableau (or the “Baccarat Card Drawing Rules”).

Once both the Player hand and the Banker hand have received all the cards required according to the Baccarat Tableau, the result of the round is announced by the dealer, e.g. “Banker wins 5 over 4”.

A bet placed on the Player wins if the Player hand has a higher final card total than the Banker hand, it loses if the Banker hand has the highest final card total, and it stands (neither wins nor loses) if the final card total of the Player and Banker hands are equal, i.e. tied.

A bet on the Banker wins if the Banker hand has a higher final card total than the Player hand, it loses if the Player hand has the highest final card total and it stands if the final card total of the Player and Banker hands are equal, i.e. tied.

A bet on a Tie wins if the final totals of the Player and Banker hands are tied, and loses in all other cases. In the event of a Tie between the Player and Banker hands, participants may remove and/or adjust their bets on the Player or the Banker before the commencement of the next round.

Once the result of the round of play has been determined, all bets are settled by the dealer (winning bets are paid, and losing bets are collected by the dealer).

A winning Player bet is paid at an equal ratio of the bet placed, i.e. for every $100 wagered, the player will be paid $100 (plus the player will retain his original bet).

A winning Banker bet is paid at a ratio of 19 to 20, i.e. a 5% commission is deducted from what is paid, i.e. for every $100 wagered a payment of $95 is made (plus the player will retain his original bet).

A winning Tie bet is paid at a ratio of 8 to 1, i.e. for every $100 wagered, the player will be paid $800, plus the player will retain his original bet. In some variations of the game the payment ratio is 9 to 1 for a winning Tie bet.

The so called “house advantage” (HA) on the respective bets refers to the mathematical calculations that determine a casino's profit on the game. This “House Advantage” indicates the difference between the odds (ratio) paid to a customer for a winning bet, and the actual probability (odds) of the event occurring.

Typically the Banker bet has a HA of 1.06%, the Player bet has a HA of 1.24%, and the Tie bet has a HA of 14.36% (at payment ratio of 8 to 1), or 4.84% (at payment ratio of 9 to 1).

The deduction of the 5% commission from a winning Banker bet is necessitated by the difference in statistical win frequency between the Player and Banker hands. The commission deduction is necessary to maintain a positive HA on the Banker bet, irrespective of the difference in the statistical win frequency between the Player and Banker hands. The statistical win frequencies are typically as follows for eight-deck Baccarat:
the Banker will win 45.85% of hands dealt;
the Player will win 44.62% of hands dealt; and
the Player and Banker hands will be tied (have the same final total) 9.52% of hands dealt.

Because winning Tie bets have no influence on Player or Banker bets (Player and Banker bets stand—neither win nor lose—in the event of a tied hand), it follows that the Banker will win 50.7% of all hands dealt which do not end up in ties, and the Player will win the remaining 49.3%. Casinos therefore charge the 5% commission on winning Banker bets to eliminate this difference in statistical win-frequency.

The Inventor believes that this traditional method of playing Baccarat has several drawbacks:
participants don't understand the need for the 5% commission payable to the casino on winning Banker bets, thinking it unfair;
the House Advantage of the Banker bet is only 1.06%, and of the Player bet 1.24%, making Baccarat the table game with the lowest average HA in the casino (1.15% on average between the Player and Banker bets). This causes casinos to be more than willing to replace their Baccarat tables with a more profitable Blackjack or Roulette table. Blackjack has a HA of 2% for the average player, going up to as much as 6% for a bad player; and double-zero Roulette has a HA of 5.3%;
to try and make up for the low average House Advantage on the primary bets (Player and Banker), most casinos insist on paying only 8 to 1 for winning Tie bets; which gives them a HA of 14.36% on the Tie bet. This high House Advantage results in very limited play of the Tie bet. The only alternative is paying 9 to 1; which leaves the casino with a HA of only 4.84%. However; most casinos consider this lowered Tie bet HA insufficient;
although a number of side-bets have been introduced to the game of Baccarat, none of them has proven to be particularly popular with the players; leaving only the traditional Player, Banker and Tie bets; and
Baccarat has established a reputation as a very boring game, as a result of having only two primary bets; for which the best possible payment is Even Money (1 to 1).

According to one aspect of the invention, there is provided a Baccarat wagering method in a game of Baccarat in which provision is made for placing a bet on an outcome of a round of play ending in a Tie between a Player hand and a Banker hand, the method including:

providing a plurality of different payment ratios or options for a successful (winning) Tie bet, each possible card total on which a Tie can occur having a pre-defined payment ratio or option associated therewith.

This method therefore deviates from the traditional payment ratio, where all winning Tie bets are paid a uniform ratio regardless of the card total on which the Tie occurs.

A first payment ratio may be associated with a round of play ending in a Tie on a final card total of 0 or 1, a second payment ratio may be associated with a round of play ending in a Tie on a final card total of 2 or 3, a third payment ratio may be associated with a round of play ending in a Tie on a final card total of 4 or 5, a fourth payment ratio may be associated with a round of play ending in a Tie on a final card total of 6 or 7, and a fifth payment ratio may be associated with a round of play ending in a Tie on a final card total of 8 or 9, at least some of the respective payment ratios being different from one another.

For example, if a Tie occurs on 0 points or 1 point, the payment to the participant may be made at a ratio of 10 to 1. If a Tie occurs on 2 or 3 points, the payment to the participant may be made at a ratio of 11 to 1. If a Tie occurs on 4 or 5 points, the payment to the participant may be made at a ratio of 9 to 1. If a Tie occurs on 6 or 7 points, the payment to the participant may be made at a ratio of 7 to 1. If a Tie occurs on 8 or 9 points, the payment to the participant may be made at a ratio of 8 to 1. The varying payment ratios may be adjusted in any number of ways; they are not limited to the payment ratios in the example.

According to another aspect of the invention, there is provided a Baccarat wagering method in a game of Baccarat in which provision is made for placing a bet on an outcome of a round of play ending in a Tie between a Player hand and a Banker hand, the method including:

providing at least two different betting options for the outcome of the round of play ending in a Tie.

A first betting option may be associated with a round of play ending in a Tie on an even card total and a second betting option may be associated with a round of play ending in a Tie on an odd card total. For example, the payment option may be a payment ratio of 17 to 1.

According to another aspect of the invention, there is provided a Baccarat wagering method in a game of Baccarat in which provision is made for placing a bet on an outcome of a round of play ending in any one of a Player hand and a Banker hand having a higher final card total than the other of the Banker hand and the Player hand, the method including:

providing a plurality of different payment ratios for a winning bet, each possible card total on which a winning hand can occur having a pre-defined payment ratio associated therewith.

At least one payment ratio may depend on an outcome of a subsequent round of play.

A first payment ratio may be associated with a final card total of from 1 to 6 for a winning Player hand, a second payment ratio may be associated with a final card total of from 1 to 6 for a winning Banker hand, a third payment ratio may be associated with a final card total of 8 or 9 for a winning Player hand, a fourth payment ratio may be associated with a final card total of 8 or 9 for a winning Banker hand, and a fifth payment ratio may be associated with a final card total of 7 for both a winning Player hand and a winning Banker hand. The fifth payment ratio may be dependent on the outcome of the subsequent round of play.

For example, if the final card totals in the winning hand add up to any total from 1 to 6, payment to a player betting on the winning hand may be made at a payment ratio of 5 to 4 for a winning Player hand, or 21 to 20 for a winning Banker hand. If the final card total of the winning hand is 8 or 9, payment to a player betting on the winning hand may be made at a payment ratio equal to that of the wager made (i.e. Even Money), for both winning Player and winning Banker hands. If the final card total of the winning hand is 7, payment to a player betting on the winning hand may be made dependent on the outcome of the next round, by advancing the bet to a “Bonus” area where additional “Bonus” payments may be won.

A plurality of payment odds or other events may be associated with the outcome of the subsequent round. The payment odds or other events in the subsequent round may be dependent on the outcome of said subsequent round and the highest final card total in said subsequent round.

For example, if the previous winning side (either Player or Banker, whichever won) wins on a card total of 7 in the subsequent round, the payment to the betting participant may be made at a payment ratio of 4 to 1. If, in said subsequent round, the Player hand and the Banker hand end in a Tie on 7 points, payment to the betting player may be made at a payment ratio of 2 to 1. If, in said subsequent round, the previous winning side wins again, on any card total other than 7, payment to the betting player may be made at a payment ratio of 3 to 2. If a Tie between the Player hand and the Banker hand occurs on any card total other than 7 in said subsequent round, the betting player's initial bet is returned (considered a stand-off). If, in said subsequent round, the previous losing side (Player or Banker, whichever lost the previous round) beats the previous winning side, the betting player will lose the bet.

Advantageously, the wagering method described above eliminates the normal requirement for payment of the traditional 5% commission on a winning Banker bet.

The wagering method described above may be used alone, or in conjunction with the traditional Baccarat wagering method.

According to another aspect of the invention, there is provided a Baccarat playing surface which includes:

at least one demarcated zone in which bets can be placed for an outcome of a round of play of Baccarat to end in a Tie between a Player hand and a Banker hand, a plurality of different payment ratios being associated with a successful Tie bet, each possible card total on which a Tie can occur having a pre-defined payment ratio associated therewith.

The Baccarat playing surface may include indicia thereon to indicate which payment ratio is associated with each possible card total on which a Tie can occur.

According to another aspect of the invention, there is provided a Baccarat playing surface which includes:

at least two demarcated zones in which bets can be placed for an outcome of a round of play of Baccarat to end in a Tie between a Player hand and a Banker hand, each demarcated zone being associated with a plurality of different possible card totals on which a Tie can occur.

There may be two demarcated zones, one demarcated zone being associated with Ties occurring on even card totals, and the other demarcated zone being associated with Ties occurring on odd card totals. Instead, or in addition, demarcated zones may be associated with individual card totals or other combinations of card totals.

According to another aspect of the invention, there is provided a Baccarat playing surface which includes:

at least one demarcated zone in which bets can be placed for an outcome of a round of Baccarat to end in one of a Player hand and a Banker hand having a higher total than the other of the Banker hand and the Player hand, a plurality of different payment ratios being associated with a winning bet, each possible card total on which a winning hand can occur having a pre-defined payment ratio associated therewith.

The Baccarat playing surface may include two demarcated zones per participant, one demarcated zone being associated with a Banker hand and the other demarcated zone being associated with a Player hand.

According to another aspect of the invention, there is provided a Baccarat playing surface which includes:

at least one demarcated zone in which, in response to a previous round satisfying predefined criteria, bets can be placed for an outcome of a round of Baccarat to end in one of a Player hand and a Banker hand having a higher total than the other of the Banker hand and the Player hand.

A plurality of different payment ratios or other events may be associated with said bet, each possible outcome which can occur having a pre-defined payment ratio or other event associated therewith.

The Baccarat playing surface may include two of said demarcated zones per participant, one demarcated zone being associated with a Banker hand and the other demarcated zone being associated with a Player hand.

The playing surface may be provided by a suitable material on a table, with the demarcated zone printed or otherwise affixed to the material.

According to another aspect of the invention, there is provided a computer program which, when executed, provides a computer controlled game of Baccarat in accordance with any method in accordance with the invention as hereinbefore described.

According to another aspect of the invention, there is provided a computer operating thereon a computer program as above defined.

According to another aspect of the invention, there is provided a data carrier or memory device having stored thereon a computer program as above defined.

The invention will now be described, by way of example only with reference to the accompanying diagrammatic drawings.

In the drawings:

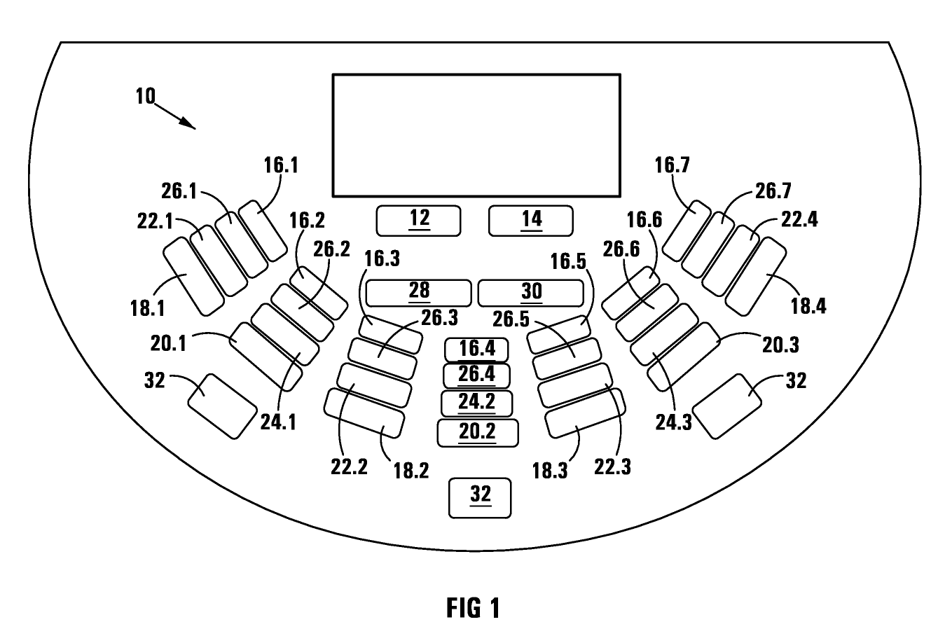

FIG. 1 shows a schematic view of one embodiment of a Baccarat playing surface in accordance with the invention; and

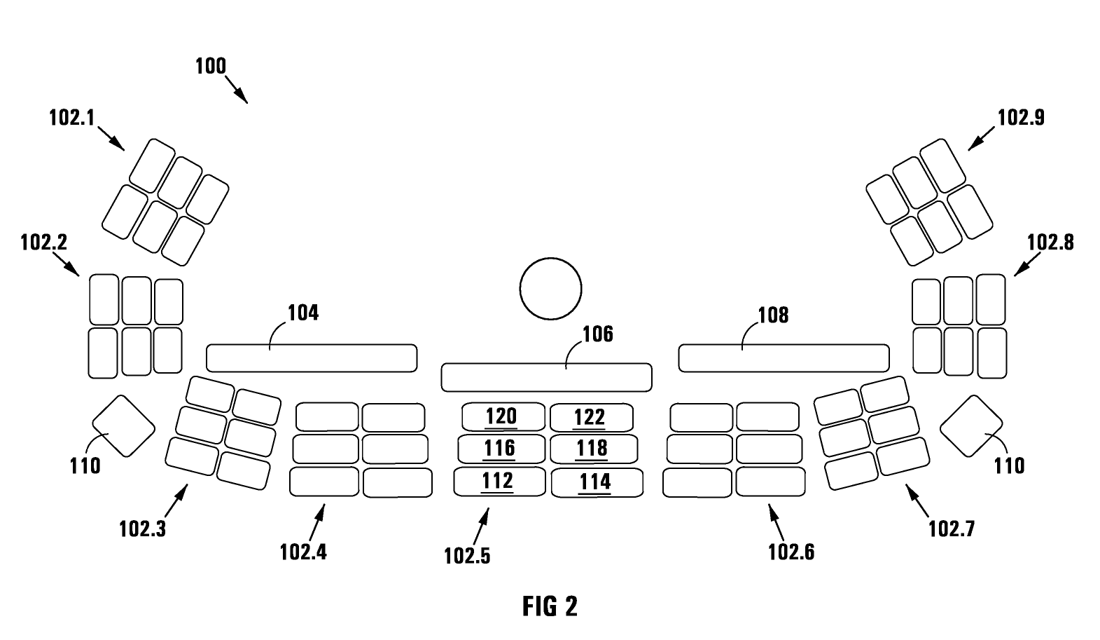

FIG. 2 shows a schematic view of another embodiment of a Baccarat playing surface in accordance with the invention.

In FIG. 1, reference numeral 10 refers to one embodiment of a Baccarat playing surface in accordance with the invention. The playing surface 10 defines the following demarcated zones: a Player-card placement zone 12, a Banker-card placement zone 14, modified Tie betting zones 16.1 . . . 16.7, Player betting zones 18.1 . . . 18.4, Banker betting zones 20.1 . . . 20.3, modified Player betting zones 22.1 . . . 22.4, modified Banker betting zones 24.1 . . . 24.3 and Bonus zones 26.1 . . . 26.7.

In addition there is provided an Even Tie zone 28 and an Odd Tie zone 30. There are also provided three information zones 32 which contain information on various payment ratios or options in the event of Ties between a Player hand and a Banker hand.

The game is played using more than one deck of cards (eight decks in this example) consisting of 52 cards per deck excluding Joker cards. The cards are shuffled by a dealer before the commencement of the game and are then dealt from a box known as a shoe.

The Baccarat version played on the playing surface 10 provides seven betting options which a betting participant can exercise as follows: bets can be placed on a Player hand winning a round, a Banker hand winning a round, a (modified) Tie between a Player hand and a Banker hand, a modified Player bet, a modified Banker bet, a Tie occurring on an odd card total (1, 3, 5, 7, or 9) and a Tie occurring on an even card total (0, 2, 4, 6, or 8).

The object of the game is to guess which of the two hands dealt (Player or Banker) in a round of play will have a final card total equal to nine, or a card total closest to nine, where nine is the highest possible count and zero the lowest count. The card total in a hand is calculated by adding the total of the cards in the hand, modulo ten. Ace cards have a value of one, ten cards and picture cards have a value of zero, and all other cards are counted at their face value. For example, if a hand consists of a picture card and a 5, the total count in the hand is 5. The card total can only range from 0 to 9. Suits e.g. Hearts, Diamonds, Clubs or Spades, have no relevance in the game.

Players indicate their bets on the Player hand winning, by placing tokens on the zones 18.1 . . . 18.4, bets on the Banker hand winning are indicated by placing tokens on the zones 20.1 . . . 20.3, bets on a modified Tie between a Player hand an a Banker hand are indicated by placing tokens on the zones 16.1 . . . 16.7, modified Player bets are indicated by placing tokens on zones 22.1 . . . 22.4, modified Banker bets are indicated by placing tokens on zones 24.1 . . . 24.3, bets on a Tie between the Player hand and the Banker hand occurring on even card totals are indicated by placing tokens on zone 28 and bets on a Tie between the Player hand and the Banker hand occurring on odd card totals are indicated by placing tokens on zone 30.

Once all bets have been placed, two cards are dealt to each of the Player and the Banker. After the cards have been dealt no further bets may be placed.

A third card may be dealt to either or both of the Player and the Banker according to the following rules:
if the Player or the Banker has a card total of 8 or 9 on the first two cards, they stand, i.e. no further cards are drawn. This rule overrides all other rules;
if the Player's initial two-card total is 5 or less, another card is dealt to the Player, otherwise the Player stands, i.e. no further card is dealt to the Player; if the Player stands, the Banker will be dealt another card only if it has an initial two-card total of 5 or less; otherwise the Banker stands, i.e. no further card is dealt to the Banker; and
if the Player is dealt a third card, the value of this card will determine whether the Banker will also receive a third card or not. The chart below is used for reference to determine whether the Banker will be dealt a third card or not, where “H” (hit) indicates that a further card is dealt and “S” (stand) indicates that no further card is dealt.

| | | Player's third card | | | | | | | | | |
|---|---|---|---|---|---|---|---|---|---|---|---|
| | | 0 | 1 | 2 | 3 | 4 | 5 | 6 | 7 | 8 | 9 |
| Banker's | 7 | S | S | S | S | S | S | S | S | S | S |
| initial | 6 | S | S | S | S | S | S | H | H | S | S |
| 2-card | 5 | S | S | S | S | H | H | H | H | S | S |
| total | 4 | S | S | H | H | H | H | H | H | S | S |
| | 3 | H | H | H | H | H | H | H | H | S | H |
| | 2 | H | H | H | H | H | H | H | H | H | H |
| | 1 | H | H | H | H | H | H | H | H | H | H |
| | 0 | H | H | H | H | H | H | H | H | H | H |

The result of the round is then announced by the dealer, e.g. “Banker wins 5 over 4”.

A bet placed on the Player wins if the Player hand has a higher final card total than the Banker hand, it loses if the Banker hand has a higher final card total than the Player hand, and it stands if the final card totals of the Player and Banker hands are equal, i.e. tied. Winning bets are paid at a ratio of 1 to 1.

A bet placed on the Banker wins if the Banker hand has a higher final card total than the Player hand, it loses if the Player hand has a higher final card total than the Banker hand, and it stands if the final card totals of the Player and Banker hands are equal, i.e. tied. Winning bets are paid at a ratio of 19 to 20, i.e. a commission of 5% is deducted.

A bet on a Tie wins if the final totals of the Player and Banker hands are tied and loses in all other cases. According to the illustrated example of the invention, a winning Tie bet is paid according to the payment ratio indicated in the table below. The payment ratios are indicated in the information zones 32.

| Final card total | Payment ratio |
|---|---|
| 0 | 10 to 1 |
| 1 | 10 to 1 |
| 2 | 11 to 1 |
| 3 | 11 to 1 |
| 4 | 9 to 1 |
| 5 | 9 to 1 |
| 6 | 7 to 1 |
| 7 | 7 to 1 |
| 8 | 8 to 1 |
| 9 | 8 to 1 |

A bet on an Odd Tie, indicated by placing tokens on zone 30, wins if the final totals of the Player and Banker hands are tied on a total of 1, 3, 5, 7, or 9 and loses in all other cases. Winning bets are paid at a ratio of 17 to 1.

A bet on an Even Tie, indicated by placing tokens on zone 28, wins if the final totals of the Player and Banker hands are tied on a total of 0, 2, 4, 6, or 8 and loses in all other cases. Winning bets are paid at a ratio of 17 to 1.

A modified Player bet is indicated by tokens placed in zones 22.1 to 22.4. The payment ratios of the bets are determined as follows:
if the Player hand wins on a total of 1, 2, 3, 4, 5, or 6, the betting player is paid at a payment ratio of 5 to 4.
if the Player hand wins on a total of 8 or 9, the betting player is paid at a payment ratio of 1 to 1.
if the Player hand wins on a total of 7, the tokens placed in zone 22.1 . . . 22.4 are not paid, but moved to the respective Bonus Player zone 26.1, 26.3, 26.5, or 26.7 immediately above the modified Player zone 22.1 to 22.4 and the payment ratio to the player then depends on the outcome of the subsequent round of play. In the subsequent round the payment to the betting player is determined as follows:
if the Player hand wins again, on a total of 7, the betting player is paid at a payment ratio of 6 to 1,
if a Tie occurs on a total of 7, the betting player is paid at a payment ratio of 3 to 1,
if the Player hand wins again, on any total other than 7, the betting player is paid at a payment ratio of 1 to 1 (“Even Money”),
if a Tie occurs on any total other than 7, the bet is declared a stand-off and the bet is returned to the participant, and
if the Banker hand wins, the bet is lost.

A modified Banker bet is indicated by tokens placed in zones 24.1 . . . 24.3. The payment ratios of the bets are determined as follows:
if the Banker hand wins on a total of 1, 2, 3, 4, 5, or 6, the betting player is paid at a payment ratio of 21 to 20.
if the Banker hand wins on a total of 8 or 9, the betting player is paid at a payment ratio of 1 to 1.
if the Banker hand wins on a total of 7, the tokens placed in zone 24.1 . . . 24.3 are not paid, but moved to the respective Bonus Banker zone 26.2, 26.4, or 26.6 immediately above the modified Banker zone 24.1 . . . 24.3 and the payment ratio to the player is made dependent on the outcome of the subsequent round to be played. In the subsequent round the payment to the betting player is determined as follows:
if the Banker hand wins again, on a total of 7, the betting player is paid at a payment ratio of 6 to 1,
if a Tie occurs on a total of 7, the betting player is paid at a payment ratio of 3 to 1,
if the Banker hand wins again, on any total other than 7, the betting player is paid at a payment ratio of 1 to 1,
if a Tie occurs on any total other than 7, the bet is declared a stand-off and the bet is returned to the participant, and
if the Player hand wins, the bet is lost.

Referring now to FIG. 2, reference numeral 100 generally indicates another embodiment of a Baccarat playing surface in accordance with the invention.

The playing surface 100 defines a plurality of demarcated zones. Some zones are grouped together to accommodate a plurality of participants. There are nine groups 102.1 . . . 102.9 of zones to accommodate nine participants. Each group 102.1 . . . 102.9 comprises a Player zone 112, a Banker zone 114, a modified Player zone 116, a modified Banker zone 118, a modified Player Bonus zone 120, and a modified Banker Bonus zone 122. In addition, there is a modified Tie zone 106, an Even Tie zone 104, and an Odd Tie zone 108. The playing surface includes indicia thereon to indicate the payment odds of the modified Tie zone 106.

The Baccarat playing rules work identically to those described for the playing surface 10, with only the table layout and the payment odds being different for the playing surface 100.

A bet placed on the Player zone 112 wins if the Player hand has a higher final card total than the Banker hand, it loses if the Banker hand has a higher final card total than the Player hand, and it stands if the final card totals of the Player and Banker hands are equal, i.e. tied. Winning bets are paid at a ratio of 1 to 1.

A bet placed on the Banker zone 114 wins if the Banker hand has a higher final card total than the Player hand, it loses if the Player hand has a higher final card total than the Banker hand, and it stands if the final card totals of the Player and Banker hands are equal, i.e. tied. Winning bets are paid at a ratio of 19 to 20, i.e. a commission of 5% is deducted.

A bet on the modified Tie zone 106 wins if the final totals of the Player and Banker hands are tied and loses in all other cases. According to the illustrated example of the invention, a winning Tie bet is paid according to the payment ratio indicated in the table below. The payment ratios are indicated in the information zones 110.

| Final card total | Payment ratio |
|---|---|
| 0 | 10 to 1 |
| 1 | 10 to 1 |
| 2 | 11 to 1 |
| 3 | 11 to 1 |
| 4 | 9 to 1 |
| 5 | 9 to 1 |
| 6 | 7 to 1 |
| 7 | 7 to 1 |
| 8 | 8 to 1 |
| 9 | 8 to 1 |

A bet on an Odd Tie, indicated by placing tokens on zone 108, wins if the final totals of the Player and Banker hands are tied on a total of 1, 3, 5, 7, or 9 and loses in all other cases. Winning bets are paid at a ratio of 17 to 1.

A bet on an Even Tie, indicated by placing tokens on zone 104, wins if the final totals of the Player and Banker hands are tied on a total of 0, 2, 4, 6, or 8 and loses in all other cases. Winning bets are paid at a ratio of 17 to 1.

A modified Player bet is indicated by tokens placed in zone 116. The payment ratios of the bets are determined as follows:
if the Player hand wins on a total of 1, 2, 3, 4, 5, or 6, the betting player is paid at a payment ratio of 5 to 4.
if the Player hand wins on a total of 8 or 9, the betting player is paid at a payment ratio of 1 to 1.
if the Player hand wins on a total of 7, the tokens placed in the modified Player zone 116 are not paid, but moved to the modified Player Bonus zone 120 immediately above the modified Player zone 116 and the payment ratio to the player then depends on the outcome of the subsequent round of play. In the subsequent round the payment to the betting player is determined as follows:
if the Player hand wins again, on a total of 7, the betting player is paid at a payment ratio of 4 to 1,
if a Tie occurs on a total of 7, the betting player is paid at a payment ratio of 2 to 1,
if the Player hand wins again, on any total other than 7, the betting player is paid at a payment ratio of 3 to 2,
if a Tie occurs on any total other than 7, the bet is declared a stand-off and the bet is returned to the participant, and
if the Banker hand wins, the bet is lost.

A modified Banker bet is indicated by tokens placed in zones 118. The payment ratios of the bets are determined as follows:
if the Banker hand wins on a total of 1, 2, 3, 4, 5, or 6, the betting player is paid at a payment ratio of 21 to 20.
if the Banker hand wins on a total of 8 or 9, the betting player is paid at a payment ratio of 1 to 1.
if the Banker hand wins on a total of 7, the tokens placed in the modified Banker zone 118 are not paid, but moved to the modified Banker Bonus zone 122 immediately above the modified Banker zone 118 and the payment ratio to the player is made dependent on the outcome of the subsequent round to be played. In the subsequent round the payment to the betting player is determined as follows:
if the Banker hand wins again, on a total of 7, the betting player is paid at a payment ratio of 4 to 1,
if a Tie occurs on a total of 7, the betting player is paid at a payment ratio of 2 to 1,
if the Banker hand wins again, on any total other than 7, the betting player is paid at a payment ratio of 3 to 2,
if a Tie occurs on any total other than 7, the bet is declared a stand-off and the bet is returned to the participant, and
if the Player hand wins, the bet is lost.

The inventor believes that the invention as illustrated provides a new version of Baccarat based on the traditional Baccarat game closely enough for players that are familiar with the game to be interested in playing this particular version. Players wanting to play the traditional Baccarat can still play the game in the traditional way, as the traditional Baccarat bets (Player and Banker) are still available on the table. The inventor believes that the house advantage (HA) of the new version of the game may result in higher profit margins for the casinos, while simultaneously providing a more exciting game to the players.

The inventor believes that, in the first embodiment, bets on the modified Player zones 22.1 to 22.4 provide a house advantage of 2.4% compared to the traditional Player HA of 1.24%. Bets on the modified Banker zones 24.1 to 24.3 provide a house advantage of 2.14% compared to the traditional Banker HA of 1.06%.

In the second embodiment, bets on modified Player zones 116 provide a house advantage of 2.41% compared to the traditional Player HA of 1.24%. Bets on the modified Banker zones 118 provide a house advantage of 2.01% compared to the traditional Banker HA of 1.06%.

In both embodiments, bets on Tie zones 16.1 to 16.7, 106 provide an average house advantage of 12.28% compared to the traditional HA of 14.36% (with standard payment ratio of 8 to 1). Bets on the Odd Tie zone 30, 108 provide a house advantage of 13.83% and bets on the Even Tie zone 28, 104 provide a house advantage of 14.89%, for an average house advantage of 14.36%, in line with the traditional HA of 14.36% on the Tie bet.

It is therefore believed that the version of Baccarat described and illustrated herein will be beneficial to a Casino while providing added amusement to the players.

1. A Baccarat wagering method in a game of Baccarat in which provision is made for placing a bet on an outcome of a round of play ending in a Tie between a Player hand and a Banker hand, the method including:
providing a plurality of different payment ratios for a successful Tie bet, each possible card total on which a Tie can occur having a pre-defined payment ratio associated therewith.

2. A method as claimed in claim 1, in which a first payment ratio is associated with a round of play ending in a Tie on a card total of 0 and 1, a second payment ratio is associated with a round of play ending in a Tie on a card total of 2 and 3, a third payment ratio is associated with a round of play ending in a Tie on a card total of 4 and 5, a fourth payment ratio is associated with a round of play ending in a Tie on a card total of 6and 7, and a fifth payment ratio is associated with a round of play ending in a Tie on a card total of 8 and 9, at least some of the respective payment ratios being different from one another.

3. A Baccarat wagering method in a game of Baccarat in which provision is made for placing a bet on an outcome of a round of play ending in a Tie between a Player hand and a Banker hand, the method including:
providing at least two different betting options for the outcome of the round of play ending in a Tie.

4. A method as claimed in claim 3, in which a first betting option is associated with a round of play ending in a Tie on an even card total and a second betting option is associated with a round of play ending in a Tie on an odd card total.

5. A Baccarat wagering method in a game of Baccarat in which provision is made for placing a bet on an outcome of a round of play ending in any one of a Player hand and a Banker hand having a higher card total than the other of the Banker hand and the Player hand, the method including:
providing a plurality of different payment ratios for a winning bet, each possible card total on which a winning hand can occur having a pre-defined payment ratio associated therewith.

6. A method as claimed in claim 5, in which at least one payment ratio depends on an outcome of a subsequent round of play.

7. A method as claimed in claim 6, in which a first payment ratio is associated with a winning card total of from 1 to 6 for a Player hand, a second payment ratio is associated with a winning card total of from 1 to 6 for a Banker hand, a third payment ratio is associated with a winning card total of 8 or 9 for a Player hand, a fourth payment ratio is associated with a winning card total of 8 or 9 for a Banker hand, and a fifth payment ratio is associated with a winning card total of 7 for both a winning Player hand and a winning Banker hand, the fifth payment ratio being dependent on the outcome of the subsequent round of play.

8. A method as claimed in claim 6 or claim 7, in which a plurality of payment odds or other events are associated with the outcome of the subsequent round, the payment odds or other events being dependent on the outcome and the highest final card total in said subsequent round.

9. A Baccarat playing surface which includes:
at least one demarcated zone in which bets can be placed for an outcome of a round of play of Baccarat to end in a Tie between a Player hand and a Banker hand, a plurality of different payment ratios being associated with a successful Tie bet, each possible card total on which a Tie can occur having a pre-defined payment ratio associated therewith.

10. A Baccarat playing surface as claimed in claim 9, which includes indicia thereon to indicate which payment ratio is associated with each possible card total on which a Tie can occur.

11. A Baccarat playing surface which includes:
at least two demarcated zones in which bets can be placed for an outcome of a round of play of Baccarat to end in a Tie between a Player hand and a Banker hand, each demarcated zone being associated with a plurality of different possible card totals on which a Tie can occur.

12. A Baccarat playing surface as claimed in claim 11, which includes two demarcated zones, one demarcated zone being associated with Ties occurring on even card totals, and the other demarcated zone being associated with Ties occurring on odd card totals.

13. A Baccarat playing surface which includes:
at least one demarcated zone in which bets can be placed for an outcome of a round of Baccarat to end in one of a Player hand and a Banker hand having a higher total than the other of the Banker hand and the Player hand, a plurality of different payment ratios being associated with a winning bet, each possible card total on which a winning hand can occur having a pre-defined payment ratio associated therewith.

14. A Baccarat playing surface as claimed in claim 13, which includes two demarcated zones per participant, one demarcated zone being associated with a Banker hand and the other demarcated zone being associated with a Player hand.

15. A Baccarat playing surface which includes:
at least one demarcated zone in which, in response to a previous round satisfying pre-defined criteria, bets can be placed for an outcome of a round of Baccarat to end in one of a Player hand and a Banker hand having a higher total than the other of the Banker hand and the Player hand.

16. A Baccarat playing surface as claimed in claim 15, in which a plurality of different payment ratios or other events are associated with a winning bet, each possible outcome which can occur having a pre-defined payment ratio or other event associated therewith.

17. A Baccarat playing surface as claimed in claim 15 or claim 16, which includes two of said demarcated zones per participant, one demarcated zone being associated with a Banker hand and the other demarcated zone being associated with a Player hand.

18. A computer program which, when executed, provides a computer controlled game of Baccarat in accordance with a method as claimed in any one of claims 1 to 8.

19. A computer operating thereon a computer program as claimed in claim 18.

20. A data carrier or memory device having stored thereon a computer program as claimed in claim 18.
